(19) United States
(12) Patent Application Publication
(10) Pub. No.: US 2026/0050540 A1
(43) Pub. Date: Feb. 19, 2026

(54) METHODS AND APPARATUS TO ANALYZE SOFTWARE APPLICATIONS

(71) Applicant: Intel Corporation, Santa Clara, CA (US)

(72) Inventors: Garritt C. Binder, Leola, SD (US); Kenneth Mark LeTourneau, El Dorado Hills, CA (US); Michael Daniel Rosenzweig, Queen Creek, AZ (US)

(73) Assignee: Intel Corporation, Santa Clara, CA (US)

(21) Appl. No.: 19/370,186

(22) Filed: Oct. 27, 2025

Related U.S. Application Data
(60) Provisional application No. 63/735,772, filed on Dec. 18, 2024.

(51) Int. Cl. G06F 11/3668; G06F 9/50

(52) U.S. Cl. CPC G06F 11/3688; G06F 9/5061

(57) ABSTRACT

This disclosure is related to software application analysis and, more particularly to, methods and apparatus to analyze software applications. An example non-transitory machine readable storage medium includes instructions to cause programmable circuitry to at least determine a first partition of a first processing resource, reallocate applications executing on the first partition, allocate an application under test to execute on the first partition, monitor execution of the application under test, and output a report associated with the execution.

### RELATED APPLICATION

This patent claims the benefit of U.S. Provisional Patent Application No. 63/735,772, which was filed on December 18, 2024. U.S. Provisional Patent Application No. 63/735,772 is hereby incorporated herein by reference in its entirety. Priority to U.S. Provisional Patent Application No. 63/735,772 is hereby claimed.

### BACKGROUND

Modern enterprise computing environments often involve fleets of devices executing numerous applications, processes, and threads that interact with shared hardware resources. These applications may consume processor cycles, memory bandwidth, cache capacity, and power in varying ways, leading to diverse system behaviors.

### BRIEF DESCRIPTION OF THE DRAWINGS

FIG. 1 is a block diagram of an example environment in which an example application analyzer circuitry operates to analyze a software application under test.

FIG. 2 is a block diagram of an example implementation of the application analyzer circuitry of FIG. 1.

FIG. 3 is a flowchart representative of example machine readable instructions and/or example operations that may be executed, instantiated, and/or performed by example programmable circuitry to implement the application analyzer circuitry of FIG. 2.

FIG. 4 illustrates example configurations of controlled partitions.

FIG. 5 is a block diagram of an example processing platform including programmable circuitry structured to execute, instantiate, and/or perform the example machine readable instructions and/or perform the example operations of FIG. 3 to implement the application analyzer circuitry of FIG. 2.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Managing and analyzing software applications across enterprise computing environments presents significant challenges for information technology (IT) administrators. Modern organizations often deploy fleets of hundreds or thousands of computing devices, each executing numerous applications with diverse resource requirements. Some applications may exhibit behaviors that degrade system performance, shorten battery life, or interfere with mission-critical tasks, yet such behaviors are not always readily apparent through conventional monitoring techniques.

Existing performance analysis approaches typically rely on operating system metrics such as overall CPU utilization, memory consumption, or input/output statistics. While such tools provide general visibility into system load, they typically do not isolate the effects of a single application under controlled conditions. In practice, these approaches may fail to differentiate between normal background activity and behavior that is detrimental to the user experience or enterprise performance requirements. For example, a background process may continuously consume processor cycles, causing latency or stuttering in a foreground application, yet remain obscured within aggregate performance measurements. Similarly, applications that repeatedly wake processor cores from low-power states can interfere with power management strategies, resulting in unnecessary battery drain.

These difficulties are amplified in large-scale enterprise environments. An application that appears well-behaved on a standalone device may cause significant degradation when executed in parallel with other workloads across a heterogeneous fleet of devices. The dynamic nature of enterprise systems, characterized by frequent software updates, multiple hardware configurations, and distributed deployment, further complicates the task of identifying misbehaving applications. What may be manageable on an individual device becomes impractical at the enterprise scale.

Known centralized management systems provide capabilities for remote administration and policy enforcement, but do not commonly provide fine-grained diagnostic mechanisms for isolating the behavior of individual applications. As a result, IT administrators typically remain reliant on reactive troubleshooting methods, user complaints, or trial-and-error testing, which consume time and resources without guaranteeing accurate identification of the problem application.

The absence of robust application-level analysis imposes significant burdens on IT administrators and end users alike. Inadequately monitored applications can cause a degraded user experience, increased helpdesk support overhead, higher energy consumption, or even security vulnerabilities if misbehaving software circumvents enterprise policies. Examples described herein provide for methods and apparatus that isolate application execution under controlled conditions, measure low-level processor and memory behaviors such as state residency, cache utilization, and sleep state transitions, and provide actionable results to administrators in a scalable and automated manner.

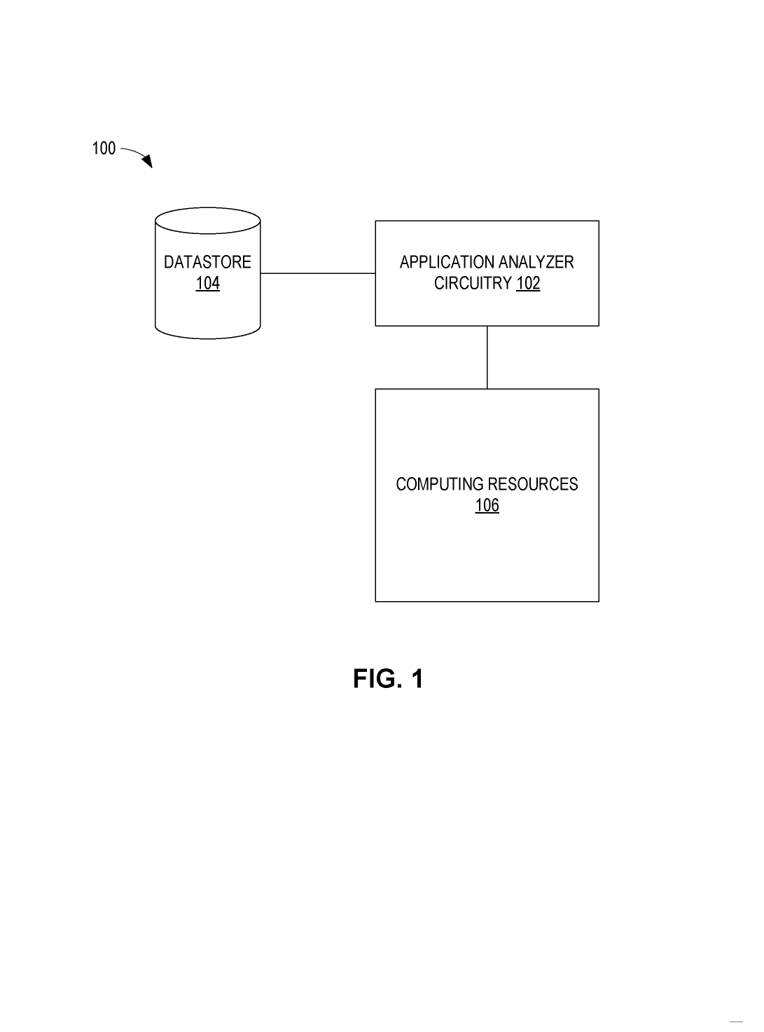

FIG. 1 is a block diagram of an example environment 100 in which an application analyzer circuitry 102 may analyze applications stored in a datastore 104 via example computing resources 106. In some examples, the computing resources 106 are networked computing resources. For example, the computing resources 106 can be part of an enterprise system of computing resources connected via a network.

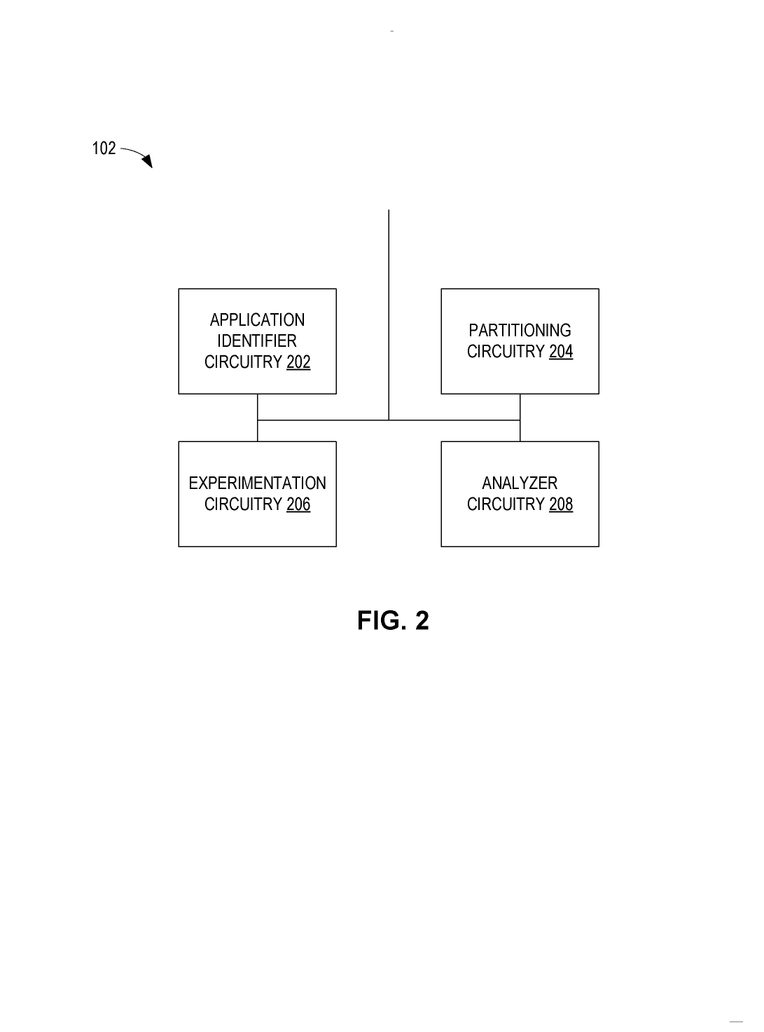

FIG. 2 is a block diagram of an example implementation of the application analyzer circuitry 102 of FIG. 1 to perform analysis of applications. The application analyzer circuitry 102 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the application analyzer circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The example application analyzer circuitry 102 includes example application identifier circuitry 202, example partitioning circuitry 204, example experimentation circuitry 206, and example analyzer circuitry 208.

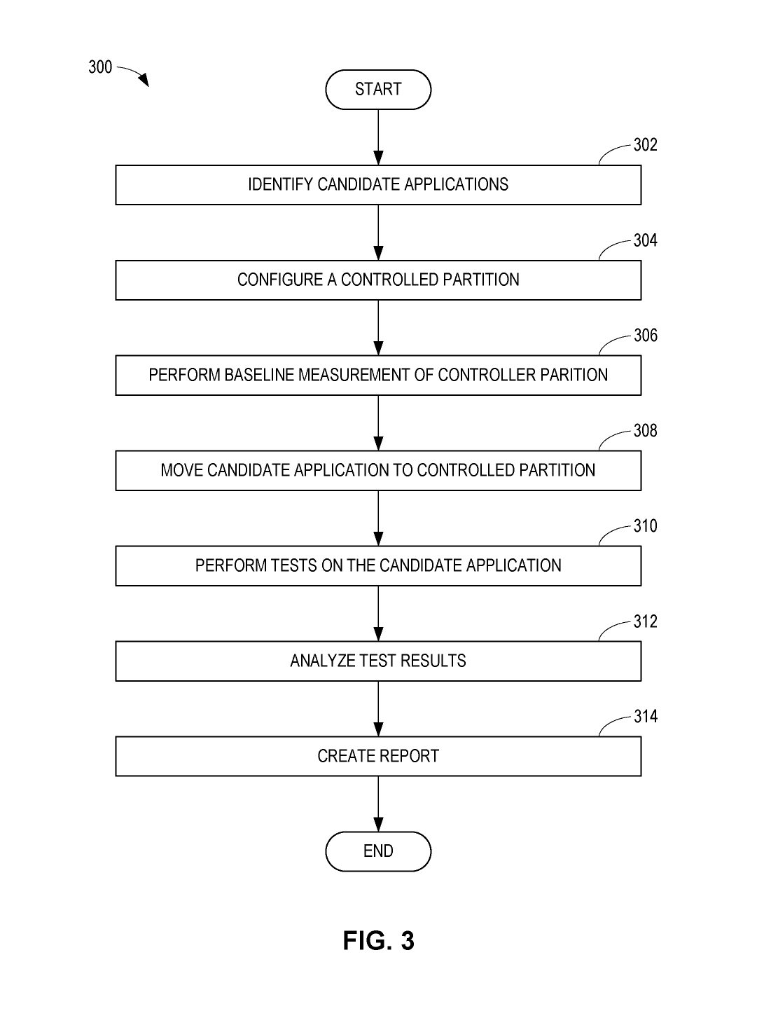

In some examples, the application identifier circuitry 202 is instantiated by programmable circuitry executing application identifier circuitry instructions and/or configured to perform operations such as those represented by the flowchart(s) of FIG. 3.

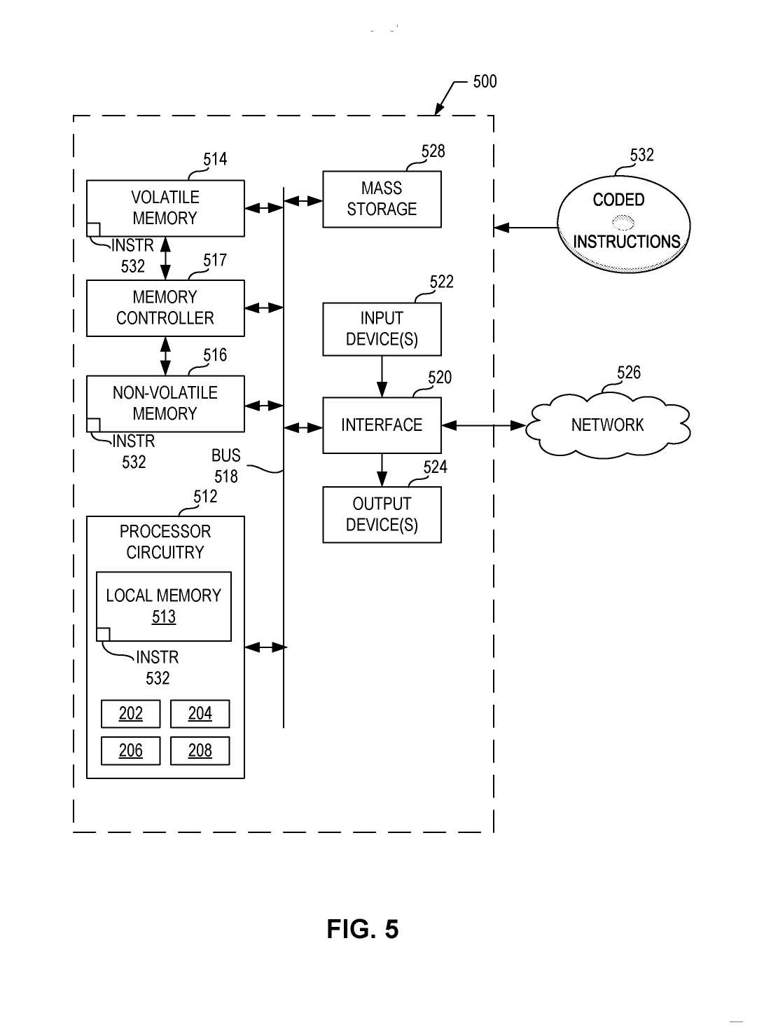

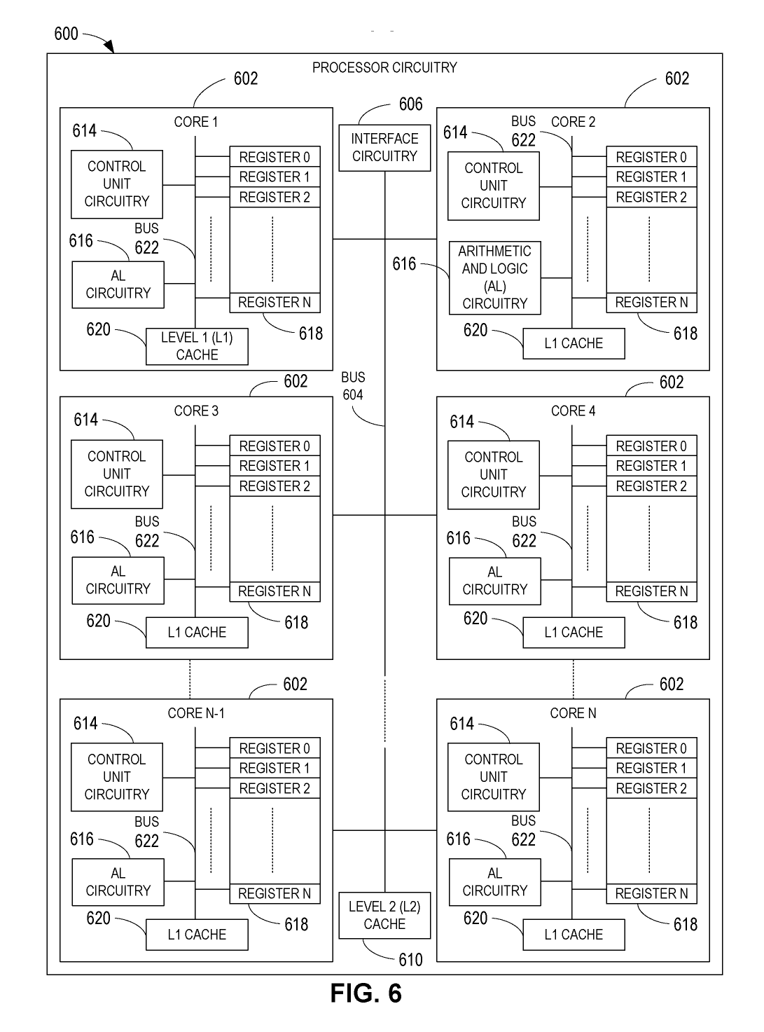

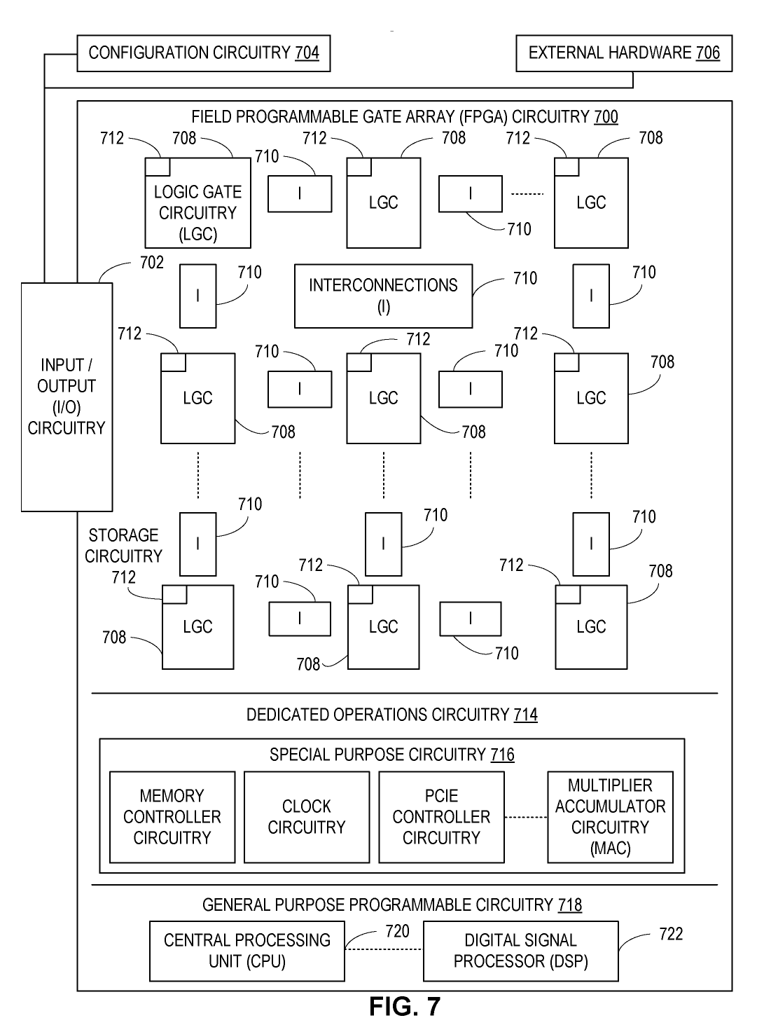

In some examples, the application analyzer circuitry 102 includes means for identifying applications for analysis. For example, the means for identifying may be implemented by application identifier circuitry 202. In some examples, the application identifier circuitry 202 may be instantiated by programmable circuitry such as the example programmable circuitry 512 of FIG. 5. For instance, the application identifier circuitry 202 may be instantiated by the example microprocessor 600 of FIG. 6 executing machine executable instructions such as those implemented by at least block 302 of FIG. 3. In some examples, the application identifier circuitry 202 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the application identifier circuitry 202 may be instantiated by any other combination of hardware, software, and/or firmware. For example, the application identifier circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the partitioning circuitry 204 is instantiated by programmable circuitry executing partitioning circuitry instructions and/or configured to perform operations such as those represented by the flowchart(s) of FIG. 3.

In some examples, the application analyzer circuitry 102 includes means for partitioning a computing resource. For example, the means for partitioning may be implemented by partitioning circuitry 204. In some examples, the partitioning circuitry 204 may be instantiated by programmable circuitry such as the example programmable circuitry 512 of FIG. 5. For instance, the partitioning circuitry 204 may be instantiated by the example microprocessor 600 of FIG. 6 executing machine executable instructions such as those implemented by at least blocks 304 and 308 of FIG. 3. In some examples, the partitioning circuitry 204 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the partitioning circuitry 204 may be instantiated by any other combination of hardware, software, and/or firmware. For example, the partitioning circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the experimentation circuitry 206 is instantiated by programmable circuitry executing experimentation circuitry instructions and/or configured to perform operations such as those represented by the flowchart(s) of FIG. 3.

In some examples, the application analyzer circuitry 102 includes means for experimenting (e.g., probing, testing) on applications. For example, the means for experimenting may be implemented by experimentation circuitry 206. In some examples, the experimentation circuitry 206 may be instantiated by programmable circuitry such as the example programmable circuitry 512 of FIG. 5. For instance, the experimentation circuitry 206 may be instantiated by the example microprocessor 600 of FIG. 6 executing machine executable instructions such as those implemented by at least block 310 of FIG. 3. In some examples, the experimentation circuitry 206 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the experimentation circuitry 206 may be instantiated by any other combination of hardware, software, and/or firmware. For example, the experimentation circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the analyzer circuitry 208 is instantiated by programmable circuitry executing analyzer circuitry instructions and/or configured to perform operations such as those represented by the flowchart(s) of FIG. 3.

In some examples, the application analyzer circuitry 102 includes means for analyzing applications (e.g., experimentation data for applications). For example, the means for analyzing may be implemented by analyzer circuitry 208. In some examples, the analyzer circuitry 208 may be instantiated by programmable circuitry such as the example programmable circuitry 512 of FIG. 5. For instance, the analyzer circuitry 208 may be instantiated by the example microprocessor 600 of FIG. 6 executing machine executable instructions such as those implemented by at least blocks 306, 312, and 314 of FIG. 3. In some examples, the analyzer circuitry 208 may be instantiated by hardware logic circuitry, which may be implemented by an ASIC, XPU, or the FPGA circuitry 700 of FIG. 7 configured and/or structured to perform operations corresponding to the machine readable instructions. Additionally or alternatively, the analyzer circuitry 208 may be instantiated by any other combination of hardware, software, and/or firmware. For example, the analyzer circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the application analyzer circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example application identifier circuitry 202, the example partitioning circuitry 204, the example experimentation circuitry 206, the example analyzer circuitry 208, and/or, more generally, the example application analyzer circuitry 102 of FIG. 2, may be implemented by hardware alone or by hardware in combination with software and/or firmware. Thus, for example, any of the example application identifier circuitry 202, the example partitioning circuitry 204, the example experimentation circuitry 206, the example analyzer circuitry 208, and/or, more generally, the example application analyzer circuitry 102, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example application analyzer circuitry 102 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the application analyzer circuitry 102 of FIG. 2 and/or representative of example operations which may be performed by programmable circuitry to implement and/or instantiate the application analyzer circuitry 102 of FIG. 2, are shown in FIG. 3. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 3, many other methods of implementing the example application analyzer circuitry 102 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to perform application analysis. The example machine-readable instructions and/or the example operations 300 of FIG. 3 begin at block 302, at which the application identifier circuitry 202 identifies candidate applications. In general, candidate applications refer to software processes, threads, or executables that may be responsible for undesirable system behavior. The identification of candidate applications may be performed in multiple ways, either individually or in combination, to accommodate the needs of different enterprise environments.

In some examples, an IT administrator may provide an explicit list of applications to the application identifier circuitry 202 to be analyzed. The application identifier circuitry 202 can distribute the list to computing devices across a managed enterprise fleet, such that each device is configured to monitor and analyze the same set of candidate applications. The administrator-defined list may be based on prior observations, reports of performance degradation, or known issues with applications or software vendors.

In some examples, the application identifier circuitry 202 can select candidate applications based on operating system telemetry or built-in performance monitoring tools. For example, the application identifier circuitry 202 may access statistics like those presented in a task manager utility, including CPU utilization, memory usage, input/output activity, or thread scheduling patterns. Applications that consistently exceed configurable thresholds, such as maintaining processor utilization above a predetermined percentage, consuming disproportionate memory bandwidth, or repeatedly waking the system from low-power states, may be flagged as candidates by the application identifier circuitry 202 for further analysis.

In some examples, the application identifier circuitry 202 can identify candidate applications based on a hypothesis-driven approach. For example, if an end-user device exhibits problems such as stuttering in foreground applications, unusually rapid battery drain, or reduced responsiveness, the application identifier circuitry 202 may hypothesize that one or more background applications are contributing to the problem. The application identifier circuitry 202 can then select those applications as candidates for detailed analysis to confirm or refute the hypothesis. Candidate application problems may include excessive cache eviction (“cache thrash”), high memory bandwidth utilization, sustained or spiking CPU (e.g., NPU, GPU, etc.) usage, unnecessary wake events, or contention with critical system processes.

The application identifier circuitry 202 may also incorporate historical data and enterprise-wide trends into its candidate selection. For example, candidate applications that have been previously identified as problematic on other devices in the fleet may be prioritized for analysis. In some examples, the application identifier circuitry 202 can apply machine learning models (e.g., ML, artificial intelligence (AI), etc.) to historical telemetry data to predict which candidate applications are most likely to cause undesirable system behavior.

The application identifier circuitry 202 can select candidate applications through direct administrator input, automated monitoring, heuristic thresholds, hypothesis-based selection, predictive models, or any suitable combination thereof. This flexibility allows the system to adapt to both static enterprise policies and dynamic runtime conditions while ensuring that potentially misbehaving applications are effectively flagged for subsequent isolation and study.

At block 304, the partitioning circuitry 204 allocates one or more logical cores of the computing resources 106 (e.g., processor, processing resources) into a controlled partition for the purpose of analyzing the identified candidate application. In this context, a controlled partition refers to a set of processing resources that have been reserved or isolated from general-purpose workloads, providing an “on-chip lab environment” in which the candidate application can be studied with reduced interference.

In some examples, the partitioning circuitry 204 selects one or more logical cores from the computing resources 106 (e.g., multicore processor), removes (e.g., reallocates) all currently executing applications, processes, or threads from those cores, and designates them exclusively for analysis. Such isolation creates a controlled region where external factors, such as competing workloads, background operating system tasks, or unrelated user activity, are minimized. The resulting environment allows for measurements that are attributable primarily to the candidate application, rather than being obscured by aggregate system behavior.

In further examples, the partitioning may extend beyond logical core assignment to include memory and cache resources configuration (e.g., adjust an amount of cache or memory allocated to the candidate applications). For example, the partitioning circuitry 204 may configure page tables, power states, frequency, memory allocation boundaries, cache way partitioning, etc. to ensure that the candidate application’s memory activity is confined to known regions and create desired conditions. By doing so, cache residency, cache eviction, and memory bandwidth utilization can be measured more accurately, without contamination from unrelated processes.

In some examples, the size and composition of the controlled partition can also be configured. For example, the partitioning circuitry 204 may allocate a single logical core for lightweight applications or may allocate multiple cores for more computationally intensive workloads. Partition size may also vary based on device capabilities. For example, commercial systems with sixteen or more cores may dedicate two or more cores for analysis with negligible impact on user experience, whereas systems with fewer cores may rely on time-slicing, virtualization, or hyper-threading techniques to achieve effective partitioning without depriving the user of sufficient processing capacity.

In some examples, partitioning may also be accomplished through virtualization technologies. For example, the partitioning circuitry 204 can execute the candidate application inside a virtual machine or container that is bound to specific hardware cores (e.g., partitions of the computing resources 106). This approach provides strong isolation and enables the controlled partition to be instantiated or torn down dynamically, depending on the availability of resources and the administrator’s policies.

In some examples, the partitioning circuitry 204 considers system conditions when forming the controlled partition. For example, the partitioning circuitry may schedule partition creation during periods of low user activity, or the partition creation may be suspended if user experience degradation is detected. In some examples, the partitioning circuitry 204 may also reconfigure the partition dynamically to accommodate different types of analyses, such as allocating additional cores for parallel profiling or adjusting memory boundaries to study specific memory access patterns.

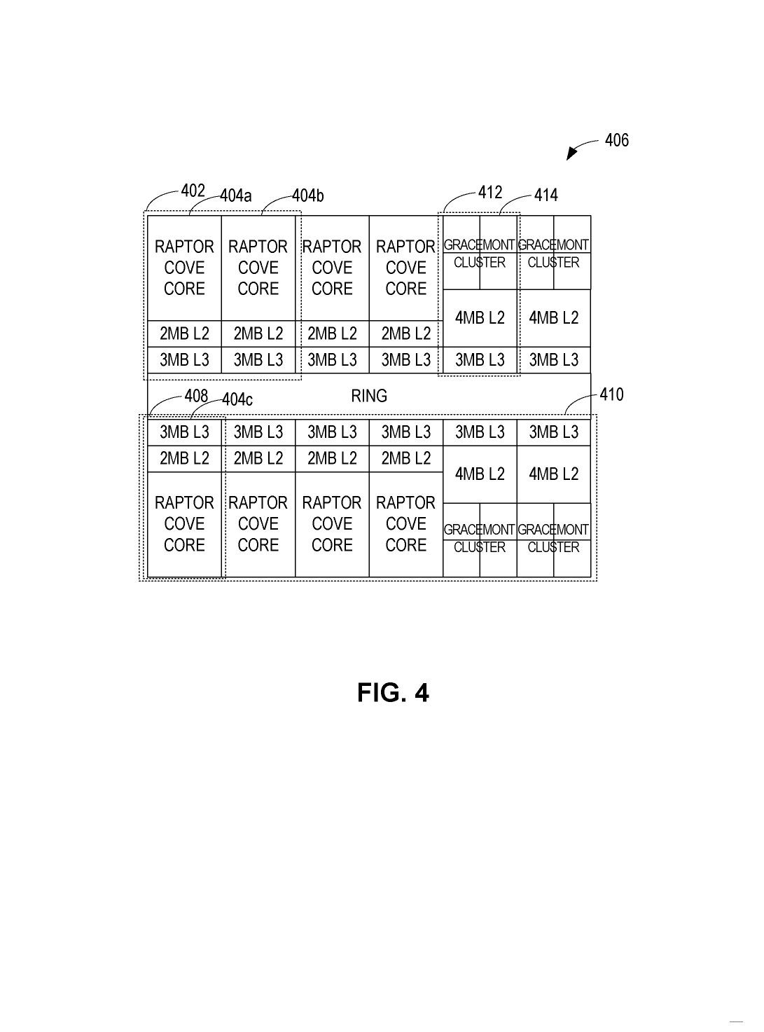

The controlled partition created by the partitioning circuitry 204 at block 304 functions as a field-deployable, on-chip analysis environment. Unlike traditional laboratory profiling, which requires specialized equipment and controlled external conditions, this approach enables real-time analysis directly on deployed devices. By creating such an environment with minimal impact on the end user, the partitioning circuitry 204 facilitates scalable and practical application analysis across enterprise fleets. Example configurations of controlled partitions are described below in reference to FIG. 4.

FIG. 4 depicts example configurations of controlled partitions. As shown in FIG. 4, multiple example configurations of controlled partitions are possible, depending on the system architecture and the desired scope of analysis. Each illustrated controlled partition demonstrates a different balance between isolation and available system resources, allowing the analysis process to be tailored to the environment in which it is deployed.

In a first example configuration 402, two performance cores (e.g., raptor cove cores) 404a, 404b of a physical core 406 are allocated as the controlled partition. In this case, both performance cores 404a, 404b share the physical core 406, including the L1 and L2 caches. By allocating both performance cores 404a, 404b of the same physical core 406, the analysis can capture interactions between hyperthreaded execution units and the associated caches (e.g., the associated L1 and L2 caches). The configuration 402 is useful when the suspected application behavior may be influenced by simultaneous multi-threading effects, such as contention for execution pipelines or cache thrashing between sibling threads.

In a second example configuration 408, a single performance core 404b is allocated for analysis when hyperthreading is not enabled. By dedicating a performance core 404c to the candidate application, all three cache levels (e.g., L1, L2, and L3) are available for measurement without interference from sibling threads. The second configuration 408 provides a clean baseline for studying application behavior in environments that do not use simultaneous multi-threading or where hyperthreading has been administratively disabled.

In a third example configuration 410, one-half of the physical core 406 and its corresponding L1 and L2 resources are allocated for analysis. Such partitioning may be achieved through hardware-assisted resource allocation, microcode features, or hypervisor-level control. This configuration 410 enables finer granularity in isolating application behavior, allowing administrators to study performance impacts while conserving available cores for user-facing workloads.

In a fourth example configuration 412, a cluster of four efficiency cores 414 is dedicated to the controlled partition. In this scenario, the L2 cache is shared within the cluster of four efficiency cores 414 and is therefore allocated exclusively to the analysis partition. By expanding the partition to multiple cores, the analysis can capture multi-threaded behavior, inter-core cache utilization, and process scheduling dynamics across a larger set of resources. This approach may be particularly useful for applications known to spawn multiple threads or processes that interact intensively with one another.

In all of the foregoing examples, cache allocation may be further refined through the use of technologies such as Intel® Cache Allocation Technology (CAT). CAT allows portions of the last-level cache (LLC) to be reserved for specific workloads, thereby reducing cache interference from other processes in the system. By allocating one or more cache “ways” to the controlled partition, the system ensures that the candidate application’s cache activity is measured in isolation, leading to more accurate profiling results. In some examples, memory allocation can also be used to ensure that the candidate application’s cache activity is measured in isolation.

The partitioning circuitry 204 may dynamically select among these configurations based on available resources, administrator policy, or the type of behavior being investigated. This flexibility enables the analysis system to operate effectively across diverse enterprise environments, from lightweight mobile devices to high-core-count servers.

Returning to FIG. 3, after the partitioning circuitry 204 creates the controlled partition control proceeds to block 306. At block 306, the partitioning circuitry 204 establishes a baseline by measuring the performance characteristics of the isolated region. The baseline represents a reference set of measurements against which the behavior of candidate applications may later be compared. Establishing a reliable baseline enables the analysis system to distinguish between normal system variability and behaviors attributable to the candidate application under test.

In some examples, the partitioning circuitry 204 measures (e.g., determines) the baseline by monitoring the partition in an idle state, where no applications, processes, or threads are executing within the partition. Measurements taken during the idle period may include CPU frequency scaling characteristics, idle power draw, leakage current, thermal gradients, and cache residency patterns associated with background system activity. This idle baseline allows subsequent measurements to be normalized against the inherent overhead of simply maintaining an active but unused partition.

In some examples, the partitioning circuitry 204 executes a known application, process, or thread within the partition to measure the baseline. For example, the partitioning circuitry 204 may launch a lightweight calibration workload such as a synthetic benchmark, microkernel routine, or a standard process with well-understood performance characteristics. By measuring this known workload, the partitioning circuitry 204 can verify that the partition is functioning correctly and that performance counters, cache monitors, and power sensors are reporting expected values.

In some examples, the partitioning circuitry 204 can store the baseline in a local or central repository for subsequent comparison. In some examples, multiple baselines may be generated under different operating conditions, such as battery-powered or AC-powered states, high ambient temperature environments, or varying system loads. The system may also maintain historical baselines over time, enabling detection of gradual hardware drift (e.g., due to aging, wear, or thermal stress) in addition to software-related anomalies.

In some examples, baselines may be adaptive or dynamic. For example, the system may refresh baseline measurements periodically to reflect firmware updates, operating system patches, or hardware configuration changes. The partitioning circuitry 204 may also apply statistical techniques to establish confidence intervals, thereby accounting for normal variance while still detecting abnormal behavior with high precision.

By creating a calibrated baseline at block 306, the partitioning circuitry 204 generally ensures that subsequent measurements of candidate applications can be accurately interpreted. Without such calibration, differences in workload, hardware configuration, or environmental conditions could produce misleading results. Accordingly, baseline calibration serves as a foundation for reliable application analysis, enabling the system to distinguish misbehaving applications from normal background variability in enterprise computing environments.

At block 308, the experimentation circuitry 206 moves one or more candidate applications into, or out of, the partitioned region. This movement (e.g., reallocating) establishes the conditions of the test by defining which applications will execute within the isolated environment. In some cases, a single candidate application may be relocated into the partition so that its behavior can be observed in isolation. In other cases, multiple applications may be moved into the partition together to study their combined behavior and any resource contention that may occur. Conversely, certain applications may be deliberately moved out of the partition to create a comparative state, allowing subsequent analysis to determine whether the removed application had been contributing to abnormal resource consumption. The movement therefore functions as a preparatory phase, ensuring that the proper execution context is established before analysis begins.

Once the appropriate applications have been placed in the controlled region, the experimentation circuitry 206 proceeds to block 310, in which the applications are observed and tested under controlled conditions. At this stage, the experimentation circuitry 206 measures resource consumption (e.g., determines if the resource consumption meets a threshold) and operational behavior (e.g., monitors execution) within the partition and compares the observed characteristics to the baseline established at block 306. Observations may be directed to a single application or to multiple applications in combination, depending on the goals of the analysis and the policies established by the administrator.

The experimentation conducted at block 310 may be varied to reveal different aspects of application behavior. For example, the duration of testing may be shortened to capture transient behaviors or lengthened to study steady-state effects over time. The available resources within the partition may also be constrained to evaluate how the application behaves under stress. Cache resources, for example, may be reduced through technologies such as Intel® Cache Allocation Technology (CAT) or by introducing synthetic workloads that consume a portion of the cache. Similarly, the number of available clock cycles may be reduced by lowering processor frequency (e.g., clock frequency) or by executing synthetic applications that compete for execution resources. These types of variations allow the system to assess whether an application continues to operate efficiently under constrained conditions or whether it exhibits pathological behaviors such as cache thrash, excessive wakeups, or disproportionate power draw.

Additional variations may involve changes to scheduling policies, adjustments to processor power management states, or the introduction of artificial I/O activity to simulate system stress. By systematically altering the conditions of the controlled partition, the experimentation circuitry 206 can develop a more complete picture of how the application consumes resources across different scenarios.

At block 312, the analyzer circuitry 208 processes the results collected during the observation phase (e.g., block 310). The processing (e.g., analysis) performed by the analyzer circuitry 208 can include comparing the observed application behavior to the baseline established at block 306, evaluating deviations that exceed predetermined thresholds, and identifying specific resource consumption patterns that suggest undesirable behavior. For example, the analyzer circuitry 208 may determine that an application consistently forces processor cores out of low-power states, generates excessive cache misses relative to baseline measurements, or consumes memory bandwidth in a manner disproportionate to its expected workload. The analyzer circuitry 208 may also apply statistical models, heuristic rules, or machine learning classifiers to distinguish between normal variability and abnormal performance.

In some examples, the analyzer circuitry 208 can generate a classification of the application based on its observed behavior. Applications may be categorized or rated numerically, for example, as normal, anomalous, or potentially harmful. Additional tags or metadata may be attached to the analysis results, such as the type of anomaly detected (e.g., power inefficiency, cache contention, thermal spike) or the severity of the observed issue. The analyzer circuitry 208 may further correlate the results with historical data from the same device or with fleet-wide data collected from other machines in the enterprise environment. This correlation enables identification of systemic issues that may not be evident when examining a single device in isolation.

At block 314, the analyzer circuitry 208 reports the analysis results. The reporting may take a variety of forms depending on system configuration and administrator preference. In some examples, the results may be output as a standalone report artifact, such as a log file, structured data record, or graphical dashboard. In other examples, the results may be transmitted to a central repository where information from multiple devices is aggregated. When aggregated, the results can be used to generate a fleet-level profile of application behavior, revealing patterns that might otherwise go undetected, such as a software update causing widespread increases in CPU utilization across different hardware platforms.

The reporting function at block 314 may also support different levels of granularity. For example, detailed measurements such as raw performance counter values, timestamps, and cache activity traces may be preserved for forensic analysis, while higher-level summaries may be presented to IT administrators for rapid decision-making. Reports may also include recommended actions, such as flagging the application for further investigation, suggesting configuration changes, or alerting administrators to apply patches or updates.

In some examples, the reporting process can incorporate security and compliance considerations. Results may be anonymized, encrypted, or filtered before transmission to ensure that sensitive application data is not inadvertently disclosed. Reports may also be formatted to comply with enterprise monitoring frameworks or industry standards, facilitating integration with existing IT management systems.

FIG. 5 is a block diagram of an example programmable circuitry platform 500 structured to execute and/or instantiate the example machine-readable instructions and/or the example operations of FIG. 3 to implement the application analyzer circuitry 102 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices. In this example, the programmable circuitry 512 implements the example application identifier circuitry 202, the example partitioning circuitry 204, the example experimentation circuitry 206, and the example analyzer circuitry 208.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIG. 3, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIG. 3 to effectively instantiate the circuitry of FIG. 2 as logic circuits to perform operations corresponding to those machine readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIG. 3.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowchart(s) of FIG. 3 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 3. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 3. As such, the FPGA circuitry 700 may be configured and/or structured to effectively instantiate some or all of the operations/functions corresponding to the machine readable instructions of the flowchart(s) of FIG. 3 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIG. 3 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIG. 3 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowchart(s) of FIG. 3 to perform first operation(s)/function(s), the FPGA circuitry 700 of FIG. 7 may be configured and/or structured to perform second operation(s)/function(s) corresponding to a second portion of the machine readable instructions represented by the flowcharts of FIG. [Flowcharts], and/or an ASIC may be configured and/or structured to perform third operation(s)/function(s) corresponding to a third portion of the machine readable instructions represented by the flowcharts of FIG. 3.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

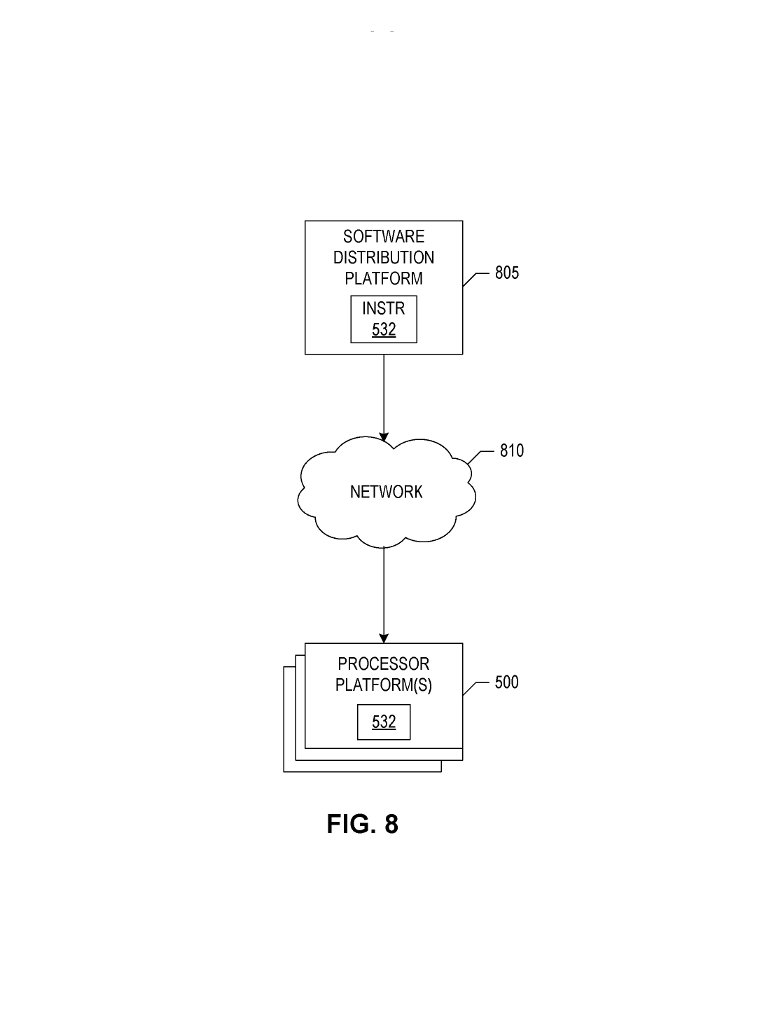

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIG. 3, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIG. [Flowcharts], may be downloaded to the example programmable circuitry platform 500, which is to execute the machine readable instructions 532 to implement the application analyzer circuitry. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/- 10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time + 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable analysis of software applications. Further examples and combinations thereof include the following:

Example 1 includes a non-transitory machine readable storage medium comprising instructions to cause programmable circuitry to at least determine a first partition of a first processing resource, reallocate applications executing on the first partition, allocate an application under test to execute on the first partition, monitor execution of the application under test, and output a report associated with the execution.

Example 2 includes the non-transitory machine readable storage medium of example 1, wherein the instructions are further to cause the programmable circuitry to determine a second partition of a second processing resource, reallocate applications executing on the second partition, and allocate the application under test to execute on the second partition.

Example 3 includes the apparatus of any one or more of examples 1-2, wherein the instructions are further to cause the programmable circuitry to allocate the application under test for execution on a plurality of networked computing resources.

Example 4 includes the non-transitory machine readable storage medium of example 3, wherein the plurality of networked computing resources are computing resources in an enterprise fleet of computing resources.

Example 5 includes the apparatus of any one or more of examples 1-4, wherein the instructions are further to detect resource consumption that meets a threshold.

Example 6 includes the apparatus of any one or more of examples 1-5, wherein the instructions are further to cause the programmable circuitry to cause the programmable circuitry to modify an amount of cache memory available to the application under test during the execution.

Example 7 includes the apparatus of any one or more of examples 1-6, wherein the instructions are further to cause the programmable circuitry to modify a clock frequency of the first processing resource during the execution.

Example 8 includes the apparatus of any one or more of examples 1-7, wherein the instructions are further to allocate the application under test via an out-of-band management resource of the first processing resource.

Example 9 includes an apparatus comprising instructions, programmable circuitry to at least one of execute the instructions or instantiate the instructions to at least determine a first partition of a first processing resource, reallocate applications executing on the first partition, allocate an application under test to execute on the first partition, monitor execution of the application under test, and output a report associated with the execution.

Example 10 includes the apparatus of example 9, wherein the programmable circuitry is to determine a second partition of a second processing resource, reallocate applications executing on the second partition, and allocate the application under test to execute on the second partition.

Example 11 includes the apparatus of any one or more of examples 9-10, wherein the programmable circuitry is to allocate the application under test for execution on a plurality of networked computing resources.

Example 12 includes the apparatus of example 11, wherein the plurality of networked computing resources are computing resources in an enterprise fleet of computing resources.

Example 13 includes the apparatus of any one or more of examples 9-12, wherein the programmable circuitry is to detect resource consumption that meets a threshold.

Example 14 includes the apparatus of any one or more of examples 9-13, wherein the instructions are further to modify an amount of cache memory available to the application under test during the execution.

Example 15 includes the apparatus of any one or more of examples 9-14, wherein the programmable circuitry is to modify a clock frequency of the first processing resource during the execution.

Example 16 includes the apparatus of any one or more of examples 9-15, wherein the programmable circuitry is to allocate the application under test via an out-of-band management resource of the first processing resource.

Example 17 includes a method comprising determining a first partition of a first processing resource, reallocating applications executing on the first partition, allocating an application under test to execute on the first partition, monitoring execution of the application under test, and outputting a report associated with the execution.

Example 18 includes the method of example 17, further including determining a second partition of a second processing resource, reallocating applications executing on the second partition, and allocating the application under test to execute on the second partition.

Example 19 includes the method of any one or more of examples 17-18, further including allocating the application under test for execution on a plurality of networked computing resources.

Example 20 includes the method of example 19, wherein the plurality of networked computing resources are computing resources in an enterprise fleet of computing resources.The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine-readable storage medium comprising instructions to cause programmable circuitry to at least:
determine a first partition of a first processing resource;
reallocate applications executing on the first partition;
allocate an application under test to execute on the first partition;
monitor execution of the application under test; and
output a report associated with the execution.

2. The non-transitory machine readable storage medium of claim 1, wherein the instructions are further to cause the programmable circuitry to:
determine a second partition of a second processing resource; reallocate applications executing on the second partition; and
allocate the application under test to execute on the second partition.

3. The non-transitory machine readable storage medium of claim 1, wherein the instructions are further to cause the programmable circuitry to allocate the application under test for execution on a plurality of networked computing resources.

4. The non-transitory machine readable storage medium of claim 3, wherein the plurality of networked computing resources are computing resources in an enterprise fleet of computing resources.

5. The non-transitory machine readable storage medium of claim 1, wherein the instructions are further to detect resource consumption that meets a threshold.

6. The non-transitory machine readable storage medium of claim 1, wherein the instructions are further to cause the programmable circuitry to cause the programmable circuitry to modify an amount of cache memory available to the application under test during the execution.

7. The non-transitory machine readable storage medium of claim 1, wherein the instructions are further to cause the programmable circuitry to modify a clock frequency of the first processing resource during the execution.

8. The non-transitory machine readable storage medium of claim 1, wherein the instructions are further to allocate the application under test via an out-of-band management resource of the first processing resource.

9. An apparatus comprising:
instructions;
programmable circuitry to at least one of execute the instructions or instantiate the instructions to at least:
determine a first partition of a first processing resource;
reallocate applications executing on the first partition;
allocate an application under test to execute on the first partition;
monitor execution of the application under test; and
output a report associated with the execution.

10. The apparatus of claim 9, wherein the programmable circuitry is to:
determine a second partition of a second processing resource;
reallocate applications executing on the second partition; and
allocate the application under test to execute on the second partition.

11. The apparatus of claim 9, wherein the programmable circuitry is to allocate the application under test for execution on a plurality of networked computing resources.

12. The apparatus of claim 11, wherein the plurality of networked computing resources are computing resources in an enterprise fleet of computing resources.

13. The apparatus of claim 9, wherein the programmable circuitry is to detect resource consumption that meets a threshold.

14. The apparatus of claim 9, wherein the instructions are further to modify an amount of cache memory available to the application under test during the execution.

15. The apparatus of claim 9, wherein the programmable circuitry is to modify a clock frequency of the first processing resource during the execution.

16. The apparatus of claim 9, wherein the programmable circuitry is to allocate the application under test via an out-of-band management resource of the first processing resource.

17. A method comprising:
determining a first partition of a first processing resource;
reallocating applications executing on the first partition;
allocating an application under test to execute on the first partition; monitoring execution of the application under test; and
outputting a report associated with the execution.

18. The method of claim 17, further including:
determining a second partition of a second processing resource;
reallocating applications executing on the second partition; and
allocating the application under test to execute on the second partition.

19. The method of claim 17, further including allocating the application under test for execution on a plurality of networked computing resources.

20. The method of claim 19, wherein the plurality of networked computing resources are computing resources in an enterprise fleet of computing resources.
